(19) United States
(12) Patent Application Publication
(10) Pub. No.: US 2009/0218706 A1
(43) Pub. Date: Sep. 3, 2009

(54) METHOD OF MANUFACTURING PHOTONIC BANDGAP FIBRE

(75) Inventor: Toshiki TARU, Yokohama-city (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 12/394,433

(22) Filed: Feb. 27, 2009

(30) Foreign Application Priority Data
Feb. 29, 2008 (GB) 0803863.0

(51) Int. Cl. B29D 11/00

(52) U.S. Cl. 264/1.28

(57) ABSTRACT

A method of manufacturing a photonic bandgap fibre comprises preparing composite rods having a central region of a first refractive index, and a surrounding region of a second refractive index. There follow steps of: selectively removing the surface of the composite rods to produce composite rods having a part with a first diameter and a part with a second diameter larger than said first diameter; stacking composite rods around a core rod; inserting the stacked rods into jacket tube to form an assembly; and reducing the jacket tube and stacked rods into fibre. Embodiments may comprise measuring the refractive index of the composite rods to calculate a ratio of diameters of the central region and surrounding region to determine an amount of the surface of the composite rods to remove. Further embodiments may comprise flowing chlorine gas through the assembly to remove impurities or moisture present in the surface of rod and jacket tube of the assembly.

### BACKGROUND OF THE INVENTION

1. Introduction

The present invention relates to a method of manufacturing an optical fibre, and more particularly to a method of manufacturing a photonic bandgap optical fibre.

2. Discussion of the Prior Art

In recent years, much interest has been focussed on developing photonic bandgap materials. These materials usually comprise two or three dimensionally periodic dielectric structures. The dielectric properties of the structures and their arrangement determine the material's light transmission characteristics. Constructive multiple-beam interference in the periodic structure can expel light from the material at certain wavelengths and angles of incidence. The wavelengths at which light is expelled and propagation does not occur is known as the photonic bandgap, and is analogous to the electronic bandgap of solid state materials except that it applies to photons rather than electrons.

Optical fibres have been developed that incorporate photonic bandgap structures. These structures have a two-dimensional periodicity in a plane normal to the direction of propagation, but the structures extend uniformly in the direction of propagation.

In conventional optical fibres, the cladding has a lower refractive index than the core. Light is forced to remain in the core by total internal reflection. In photonic bandgap fibres, the core may have a lower refractive index than the cladding. The optical confinement arises by virtue of the cladding exhibiting photonic bandgaps which prevent propagation in the cladding.

Up until recently, optical fibres exhibiting a true photonic bandgap effect had been realised by air-silica structures (FIG. 1). In such structures, air holes are incorporated in the cladding material. However, in the fabrication of these photonic bandgap fibres, it is difficult to control the geometry of the air holes.

Recently, developments in the field of photonic bandgap fibres have resulted in fibres comprising true optical bandgaps with low index contrast, and without the need for the inclusion of air holes. Such all-solid fibres include a periodic arrangement of doped glass. For example, FIG. 2A shows schematically a photonic bandgap fibre comprising a periodic arrangement of high refractive index rods 202 formed in a low refractive index cladding or background material 204. The core 206 of the fibre is also low refractive index. In the example in FIG. 2A, the photonic bandgap fibre is manufactured from rods stacked together. The core 206 is made from a pure silica rod with a low refractive index, and the cladding is made from multimode fibre preform rods with a high index core. Multimode fibre preform rods are stacked around the pure silica rod core. By heating the stacked rods and extending, or drawing while the glass is soft, a photonic bandgap fibre can be produced. However, the method and materials used suffer from a number of problems that make the manufacture of solid photonic bandgap fibres difficult.

A first problem relates to water or metal formed or absorbed into the surface of the rods. This will result in impurities in the manufactured fibre. Impurities are known to increase the loss of fibres. In the case of photonic bandgap fibres, the large number of rods used in preparing the preform for drawing will result in a much increased surface area compared to a standard optical fibre. Thus, the total amount of impurities absorbed will be greatly increased. This results in the absorbed impurities increasing the loss of the resulting fibre.

Secondly, small variations in the diameters of the stacked multimode rods making up the cladding of the photonic bandgap fibre can result in a variation in the precise wavelength at which the bandgap occurs. A numerical model quantifying the relation between the diameter of the high index rods 202 and the wavelength of the bandgap has been produced by Lichtinitser et al. in “Resonances in microstructured optical waveguides” Opt. Express Vol. 11, No. 10, 1243-1251 (2003). The model uses the assumption that the wavelength of each bandgap edge in the photonic bandgap fibre is coincident with the cut-off wavelength of each mode guided in the high index rod 202 itself.

For a high index rod 202 having a simple step-like cross-sectional refractive index profile shown in FIG. 2B, the wavelength of a bandgap edge may be estimated using the following equation:

$${λ}_{m} = \frac{2 {d}_{1} \sqrt{{n}_{1}^{2} - {n}_{2}^{2}}}{m + 1 / 2} \qquad Equation 1$$

where λₘ is the wavelength of an m-th bandgap edge (m=1, 2 . . . ), d₁ is a diameter of a high-index rod 202, n₁ and n₂ are refractive indices of a high-index rod 202 and background material 204. Typical transmission characteristics and the relation to the 1st order cut-off wavelengths are shown in FIG. 3.

If the diameter d₁ of each high index rod 202 varies along its length, or from rod to rod, the wavelength of the bandgap edge will not be consistently the same. The resulting accumulation of a range of wavelengths of bandgap edges from all the rods forming the photonic bandgap fibre will result in a narrowing of the usable band of the fibre.

### SUMMARY OF THE INVENTION

The present invention seeks to overcome the problems of the prior art. To achieve these and other advantages, the present invention provides a method of manufacturing a photonic bandgap fibre, comprising the steps of: preparing composite rods having a central region of a first refractive index, and a surrounding region of a second refractive index; selectively etching the surface of the composite rods to produce composite rods having a part with a first diameter and a part with a second diameter larger than said first diameter; stacking the composite rods around a core rod; inserting the stacked rods into a jacket tube to form an assembly; and reducing the jacket tube and stacked rods into a fibre.

The step of reducing the jacket tube and stacked rods into a fibre may comprise: collapsing the jacket tube onto the stacked rods to form a preform; and drawing the preform into a fibre. Alternatively, the step of reducing the jacket tube and stacked rods into a fibre may comprise: drawing the assembly into a fibre while the jacket tube collapses onto the stacked rods. In such a case, the assembly may be sealed at both ends after the chlorine is flowed through the assembly.

The step of preparing the composite rods may comprise the steps of: preparing a composite body having a central region of a first refractive index, and a surrounding region of a second refractive index; measuring the refractive index profile of the composite body; using the measured refractive index profile to calculate a ratio of the diameters of the central region and surrounding region; removing a surface layer of the composite body to produce a specific ratio of the diameters of the central region to the surrounding region; and elongating and cutting the composite body to form a plurality of composite rods. The second refractive index may be lower than said first refractive index. The core rod may have a refractive index lower than said first refractive index.

The present invention further provides a method of manufacturing a photonic bandgap fibre, comprising the steps of: preparing a composite body having a central region of a first refractive index, and a surrounding region of a second refractive index; measuring the refractive index profile of the composite body; using the measured refractive index profile to calculate a ratio of the diameters of the central region and surrounding region; removing a surface layer of the composite body to produce a specific ratio of the diameters of the central region to the surrounding region; elongating and cutting the composite body to form a plurality of composite rods; stacking the composite rods around a core rod; inserting the stacked rods into a jacket tube to form an assembly; and reducing the jacket tube and stacked rods into a fibre.

The present invention also provides a method of manufacturing a photonic bandgap fibre, comprising the steps of: preparing composite rods having a central region of a first refractive index, and a surrounding region of a second refractive index; stacking the composite rods around a core rod; inserting the stacked rods into a jacket tube to form an assembly; flowing chlorine gas through the assembly; and reducing the jacket tube and stacked rods into a fibre.

In each of these embodiments, as an alternative to chlorine gas, a gas comprising a chlorine compound may be used.

### BRIEF DESCRIPTION OF THE DRAWINGS

The prior art and embodiments of the invention will now be described, by way of example, with reference to the accompanying drawings of which:

FIG. 1 is an SEM image of a photonic bandgap fibre with air holes as known form the prior art;

FIG. 2A is a representation of a photonic bandgap fibre of an embodiment according to the present invention;

FIG. 2B illustrates the radial refractive index profile of the photonic band gap fibre along the cross-section A-A of FIG. 2A;

FIG. 3 shows schematically the variation in transmission with wavelength, and cut-off wavelengths of a photonic bandgap fibre;

FIG. 4 is a flow chart showing the method steps in forming composite rods which are used to form high index elements in the photonic bandgap fibre;

FIG. 5 is a flow chart showing the method steps of manufacturing the photonic bandgap fibre from the composite rods;

FIGS. 6A to 6C show schematically how the component parts are used to form the photonic bandgap fibre;

FIG. 7 is a schematic representation of a composite rod profile that may be used during the manufacturing of photonic bandgap fibre; and

FIG. 8 is a flow chart showing an alternative method of manufacturing the photonic bandgap fibre from the composite rods.

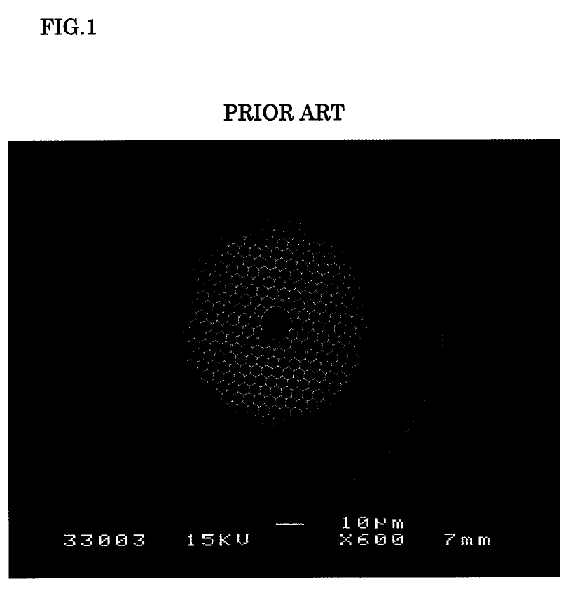

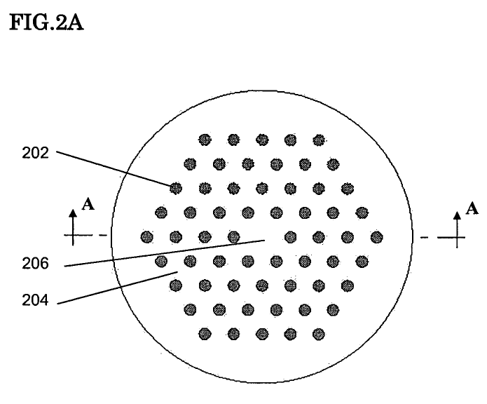

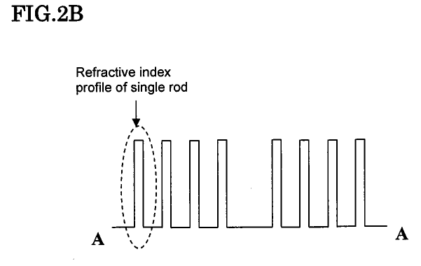

### DETAILED DESCRIPTION OF THE PREFERRED EMBODIMENTS

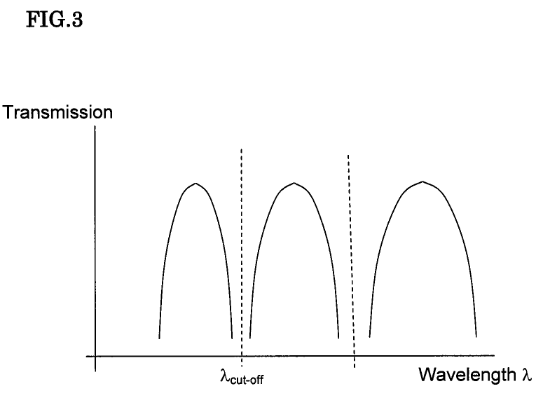

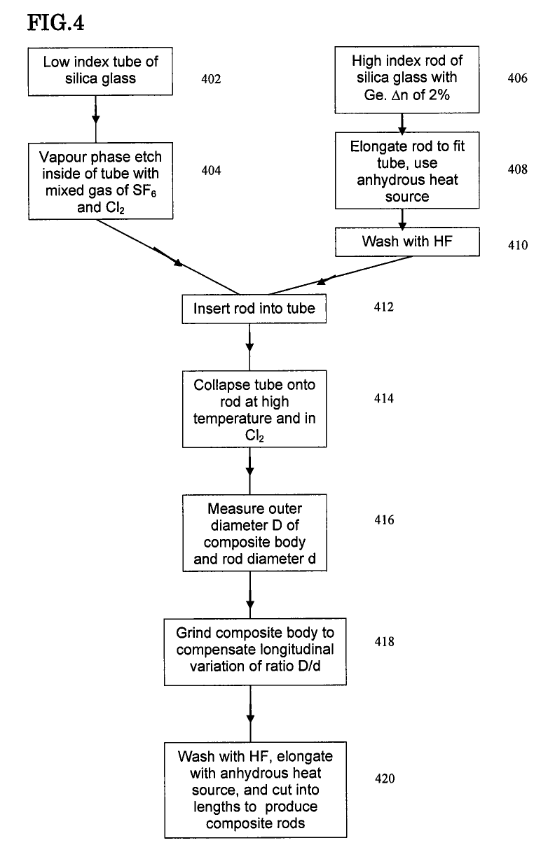

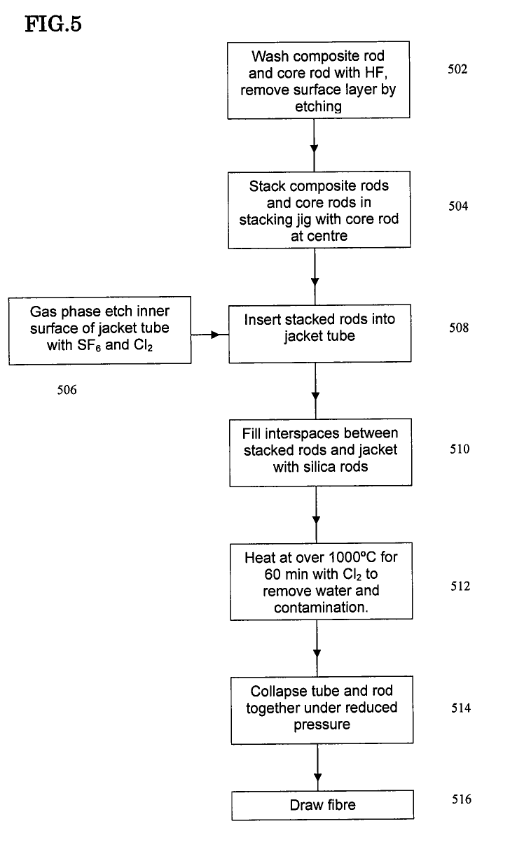

FIGS. 4 and 5 list the method steps performed in the manufacture of a photonic bandgap fibre. In particular, the method may be considered in two parts. Firstly, the manufacture of composite rods, of which the method steps are listed in FIG. 4, and secondly, the manufacture of the photonic bandgap fibre from the composite rods and a jacket tube, the method steps of which are listed in FIG. 5. FIG. 6 shows how the component parts of the photonic bandgap fibre are assembled.

The manufacturing method for an all solid photonic bandgap fibre will now be described in detail. As mentioned above, we must first consider the production of the composite rods. These are made from a low refractive index tube 610 and high refractive index rod 620 which are themselves made by vapour phase axial deposition (VAD) or outside vapour phase deposition (OVD). Preferably, the refractive index difference

$$\frac{{n}_{rod} - {n}_{tube}}{{n}_{rod}}$$

between the tube 610 and the rod 620 is 2%. The tube 610 may be made of silica glass having no additives, and the rod 620 may be made of silica glass containing germania (GeO₂, also known as germanium dioxide). Other additives or dopants such as alumina (Al₂O₃), phosphorus oxide (P₂O₅), or chlorine may be used for the core rod, and fluorine, or boron oxide (B₂O₃) for the tube.

The high refractive index rod 620 is elongated (step 408) to fit the bore diameter of the low index tube 610 using an anhydrous heat source, and is washed with hydrofluoric acid to remove particulate deposits on the surface of the rod. The inside of the low-index tube is vapour phase etched 404 with a gas mixture containing sulphur hexafluoride (SF₆) and chlorine (Cl₂) to remove impurities and moisture from the surface. The high index rod is inserted 412 into the low index tube. Subsequently, the low-index tube is collapsed 414 onto the high-index rod at high temperature and in a chlorine atmosphere, thereby forming a composite body 630. The chlorine gas and high temperature are used to remove any remaining impurities or moisture present in the surface layers of the rod and tube.

Alternative methods may be used to form the composite body such as using vapour phase axial deposition (VAD), outside vapour phase deposition (OVD), or modified chemical vapour deposition (MCVD).

The next step 416 is to perform an analysis of the composite body 630. The outer diameter, D, of the composite body, the diameter d of the rod, and the refractive indices of the tube and rod are measured using a preform analyzer. Such an analyser transmits light through the composite body orthogonal to the composite body axis. The analyser scans along the length of the composite body observing variations in diameter and refractive index. (An example analyser is the Photon Kinetics 2600 Preform Analyser). Measurements are taken using the preform analyser at a plurality of points along the composite body and the ratio of the diameters D/d is calculated. The composite body is then ground to compensate for variations in the ratio D/d along its length. The amount of grinding changes to compensate for the longitudinal variation in the ratio D/d. Preferably, the amount of grinding is sufficient to completely remove moisture existing in the surface layer of the composite body. Such grinding is particularly necessary if the step 414 of collapsing the low-index tube onto the high index rod has been performed using an oxy-hydrogen burner. Preferably, more than 1 mm in diameter of the surface layer is removed during the grinding process. This reduces the excess loss due to residual water in the surface layer of the composite body. Typically, removal of more than 1 mm in diameter of the composite body results in a loss of less than 1 dB/km. More preferably, by removing more than 2 mm of the diameter of the composite body results in reducing the excess loss to almost zero.

As well as controlling loss and adjusting the ratio D/d of the composite body, a longitudinal variation in the refractive index may also be compensated for by grinding. In particular, as mentioned above in relation to the prior art, the cut-off wavelength and, thus, bandgap wavelength is dependent on the diameter, d, of the high index rod 620 and the refractive indices n₁ and n₂ of the tube 610 and rod 620. Measurements of the refractive index profile are taken at a plurality of points along the length of the composite body. A cut-off wavelength (corresponding to the bandgap wavelength) at each of the points can then be calculated. Next, an outer diameter of the composite rod to provide a uniform cut-off wavelength along the length of the rod is calculated. The composite body may then be ground by varying amounts along its length to provide a composite body with a uniform cut-off wavelength. This grinding may be performed using a numerical control lathe to suppress changes in the cut-off wavelength to around 0.1%.

After the grinding process 418, the composite body is washed in hydrofluoric acid, again, this is to remove particles deposited on the surface of the body. The body is elongated using an anhydrous heat source, and cut into lengths 420 to form composite rods.

The core of the photonic bandgap fibre is formed from a single rod of pure silica glass. This is known as the core rod 640. The core rod is prepared by washing with hydrofluoric acid, is elongated into a rod of the same diameter as the composite rods, and cut into pieces of the same length as the composite rods.

In all of the above described embodiments, it is desirable that the concentration of hydroxyl groups (—OH group), which is derived from water, and of metal impurities in the bulk glass material used for the composite body and the core rod are less than 0.5 parts per billion (ppb) and 0.01 ppb, respectively. These values correspond to an excess loss of <0.03 dB/km at 1.38 um and <0.005 dB/km at 1.55 um, respectively. These values are sufficiently low compared to excess losses caused by contaminants on the glass surface. These low-loss bulk glass materials are available using conventional fibre preform fabrication techniques.

FIG. 5 lists the steps for forming the photonic bandgap fibre from the prepared composite rods 631 and core rod 640. The composite rods 631 are washed with hydrofluoric acid, and then at least 10 μm of the surface layer of the rods is removed by etching using the hydrofluoric acid. This etching step 502 helps to avoid problems if the composite rod is formed of doped glass. For example, if the low index tube 610 mentioned above that is used to form the composite body is made of silica glass with fluorine doping, the fluorine may diffuse from the surface layer during the elongation process. This may cause the surface layer to have as significantly different refractive index and hence, may affect the bandgap of the fibre. In some cases, a small change in the refractive index of the cladding (also known as background material in relation photonic bandgap fibres) may even prevent light from propagating in the fibre.

The composite rods 631 and core rod 640 are stacked in a stacking jig 645 as shown in FIG. 6B. The rods are stacked with a cross-section having a two dimensional triangular lattice arrangement. The outer shape of the stack has a hexagonal cross-section. The core rod 640 is located at the centre of the stacked rods 632.

A pure silica glass jacket tube 650 is prepared. The inner surface of the jacket tube is gas phase etched with a gas mixture containing sulphur hexafluoride (SF₆) and chlorine (Cl₂). The stacked rods 632 are then inserted 508 into the jacket tube 650, and any interspaces between the jacket tube and the stacked rods 632 are filled with pure silica rods of varying diameters 660 to form the assembly 670 as shown in FIG. 6C. The assembly 670 is set on a lathe and then heated 512 at a temperature above 1000° C. using a travelling oxy-hydrogen burner or furnace for 60 minutes with 200 sccm (standard cubic centimetres per minute) of chlorine gas flowing through the tube. The chlorine gas acts as a dehydrating agent above 500° C., while at a temperature of 500-1000° C. it can also remove metallic impurities from the surfaces of the rods and jacket tube 650.

Other chlorine atom-containing reactive gases may be used. For example, SOCl₂, SiCl₄, GeCl₄ or CCl₄, may be used instead of Cl₂ in the step 512. Mixed gases such as Cl₂ in combination with any of O₂, N₂, Ar or He may also be used. For mixed gases, the concentration of Cl₂ is preferably larger than 30%. It is desirable that the due point of these gases is below −30° C. Shortly, after the step of heating in a chlorine atmosphere 512, the rods and jacket tube 650 are collapsed together to form a preform. The collapse 514 is carried out at reduced pressure, for example, at less than 1 kPa. The collapse process removes any voids between the rods and thereby prevents any moisture contaminating the rods inside the preform. Finally, a fibre is drawn 516 from the preform using conventional fibre drawing techniques.

An additional step may be performed just before the chlorine treatment to reduce the water content of the assembly 670 effectively. This step is done for the purpose of removing the physically absorbed water or hydrogen atom containing substances on the surface of the stacked rods 632. The physical absorption of the water on the glass surface is unavoidable as long as the glass materials are handled in an ordinary atmosphere, and the amount absorbed becomes larger as the surface area increases. At high temperature, above around 250° C., the absorbed water may react with the glass body at its surface by the following chemical formulae:

SiO₂+H→Si—OH. Equation 2

Once the hydroxyl group (—OH group) is thus produced, it is difficult to remove fully in the succeeding process.

In the above embodiment, at the beginning of the chlorine treatment step there is a possibility that the above reaction proceeds faster than the dehydrating reaction because the dehydration reaction needs a high temperature, above 500° C., and the amount of the water present may be large. Therefore, it is desirable that the high temperature chlorine treatment process is done after reducing the water content on the glass surface. In this embodiment, the assembly 670 is purged of moisture by blowing dried (i.e. dehydrated or anhydrous) gas from one end of the tube to the other end just before the chlorine gas treatment step. The type of the dried gas used in this step includes nitrogen, helium, argon, and oxygen. It is desirable that the concentration of water or hydrogen atom containing substances in the dried gas is less than 10 vol. ppm, and more desirably 1 vol. ppm or less. It is desirable that the flow rate of the dried gas per minute is at least 10 times larger than the inner volume of the glass tube where the stacked rods 632 are assembled. Such volumes of the gas are sufficient to reduce back diffusion of the water molecules or hydrogen atom-containing substances from downstream in the gas. It is desirable that the purging is carried out for at least one hour to sufficiently reduce the amount of the water or hydrogen atom containing substances.

When the purging step is performed, the glass tube may be heated. The heating can be performed using a heater, for example a cylindrical mantle heater or a tape heater, wound on the surface of the jacket tube. When the tube is heated during the purging process, the absorbed molecules can obtain energy to desorb from the surface of the glass, so that the duration of the purging process can be shortened. In that case, it is desirable to heat the stacked rods 632 at a temperature higher than 100° C. because H₂O, which is main hydrogen atom-containing absorbed substance, has a boiling point of 100° C. However it is desirable to heat the glass pipe lower than 250° C. Above this temperature, the physically absorbed water may react with the glass body as described above.

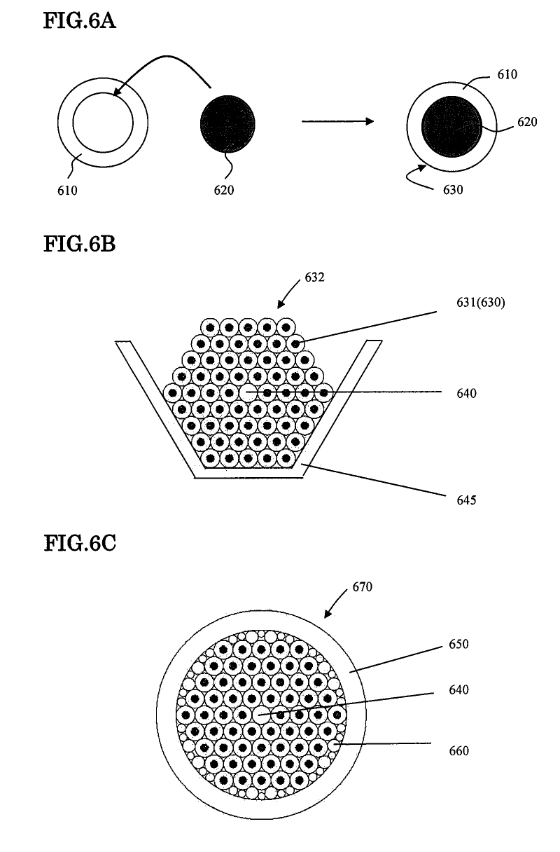

In an alternative embodiment, the effectiveness of the chlorine treatment described above at step 512 may be improved. In the above embodiments, the rods are densely packed in the stacking arrangement and, hence, the chlorine cannot come into contact with the full surface of all of the stacked rods 632 easily. In this alternative embodiment, the stacked rods 632 are shaped by selective etching. In particular, the amount of etching at the ends of the rods during step 502 is reduced, or the etching is prevented completely. This may be done by wrapping the ends of the rods with Teflon tape during the hydrofluoric acid etching process 502. The resulting rods have a dumbbell shape as shown in FIG. 7. When the rods are stacked and heated in the chlorine atmosphere, the central portions of the rods will be spaced apart thereby allowing the chlorine to come into contact with the surface of the rods more reliably. This improves the dehydration and metallic removal process 512. The difference in diameter of the non-etched ends of the rods and the etched central portions are around 10's of microns. Preferably, the non-etched end portions of the rods are between 30 and 50 mm in length. This selective etching process does not significantly reduce productivity as the end portions of the rods do not form the product and are discarded during the fibre drawing process.

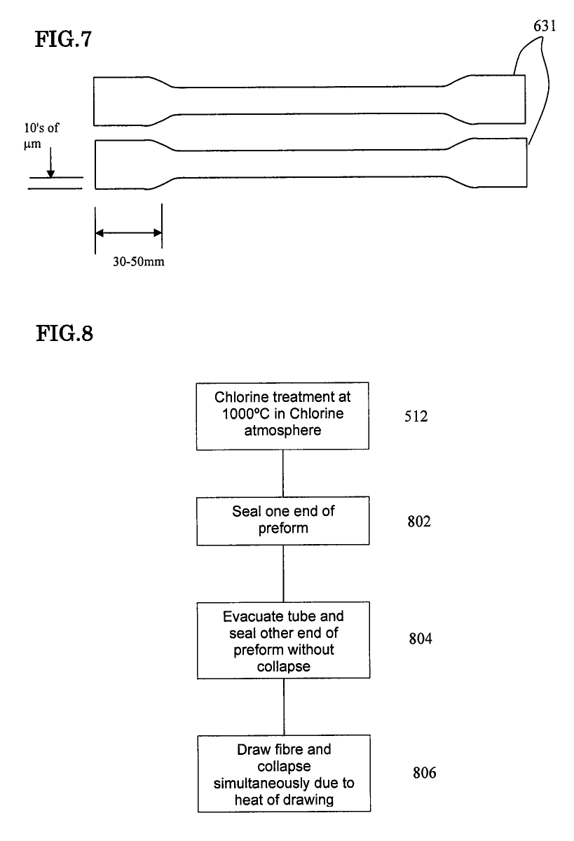

In a third embodiment, the final collapse of the jacket tube and fibre described as step 514 can be carried out at the same time as drawing the fibre. FIG. 8 lists the steps in this process. After the chlorine treatment at step 512 is completed, one end of the preform is completely sealed 802, the inside of the jacket tube is evacuated, and the other end of the tube is sealed without collapsing the tube 804. The inside of the jacket tube will comprise rods surrounded in a vacuum. Hence, when the preform is heated to allow the fibre to be drawn, the jacket tube will automatically collapse 806. In this method, the inner surface of the jacket tube, and the surface of the rods, will have reduced amounts of moisture and contaminants because the preform was sealed after the chlorine treatment up until drawing of the fibre. Another advantage of this method relates to the use of glass rods having a high thermal expansion coefficient, such as silica rods doped with high concentrations of germania, or silica doped with boron oxide (B₂O₃). Under normal manufacturing conditions, the high thermal expansion coefficient may cause the preform to crack. However, by using this method of collapse at the time of fibre drawing the cracking may be prevented. Furthermore, yet another advantage of this method is that by varying the size of the preform, the duration required for collapse may be reduced.

The above described embodiments allow an all solid photonic bandgap fibre to be manufactured with better precision than previous methods. This means the fibres are more likely to meet design constraints and more likely to have low loss and good transmission characteristics. In particular, the variation in cut-off wavelengths of the composite bodies is reduced to around 0.1%. The diametric accuracy of the elongation process is less than or equal to 1% and is now the dominant characteristic causing variation in the band gap of the photonic bandgap fibre.

In addition, transmission loss due to the presence of impurities can be reduced to a level equivalent to most widely used optical fibres. This is largely because the chlorine treatment removes the majority of impurities from the surface of the stacked rods 632. All-solid photonic bandgap fibre manufactured without the use of chlorine have excess losses of 15-20 dB/km at 1.55 μm due to impurities, and an excess loss of 10-20 dB/km at 1.38 μm due to the presence of moisture during manufacture. The loss was measured using a conventional cut-back method. Comparison of a standard single mode fibre produced using the above chlorine treatment (but in this case applied to the surface of the core rod and the inner surface of the tube) suggests that the excess loss due to the presence of water and impurities may be reduced to levels comparable to single mode fibre produced using standard techniques. For example, a test single mode fibre produced using the chlorine treatment described above resulted is an excess loss below the measurement limit at 1.55 μm, and an excess loss of 0.05 dB/km at 1.38 μm due to the presence of water. This is comparable with standard single mode fibre.

The person skilled in the art will readily appreciate that the above described invention may be changed in many ways without departing from the scope of the appended claims. For example, the embodiments described above use fluorine doped silica and germanium doped silica, but the skilled person will appreciate that glass types other than silica maybe used and other dopants may be used. In addition, the precise geometry and sizes of the fibre, rods, and components may be altered without departing from the scope of the claims.

1. A method of manufacturing a photonic bandgap fibre, comprising the steps of:
preparing composite rods having a central region of a first refractive index, and a surrounding region of a second refractive index;
selectively etching the surface of the composite rods to produce composite rods having a part with a first diameter and a part with a second diameter larger than said first diameter;
stacking the composite rods around a core rod;
inserting the stacked rods into a jacket tube to form an assembly; and
reducing the jacket tube and stacked rods into a fibre.

2. The method of claim 1, wherein one or both of the ends of the rods is the part having a second diameter larger than the first diameter.

3. The method of any of claims 1 or 2 wherein the step of reducing the jacket tube and stacked rods into a fibre, comprises:
collapsing the jacket tube onto the stacked rods to from a preform; and
drawing the preform into a fibre.

4. The method of any of claims 1 or 2 wherein the step of reducing the jacket tube and stacked rods into a fibre, comprises:
drawing the assembly into a fibre while the jacket tube collapses onto the stacked rods.

5. The method of any of claims 1 to 4, further comprising the step of:
flowing chlorine gas or a gas comprising a chlorine compound through the assembly.

6. The method of claim 4, wherein chlorine gas or a gas comprising a chlorine compound is flowed through the assembly and the assembly is sealed at both ends.

7. The method of any of claims 1 to 6, wherein the step of preparing the composite rods comprises the steps of:
preparing a composite body having a central region of a first refractive index, and a surrounding region of a second refractive index;
measuring the refractive index profile of the composite body;
using the measured refractive index profile to calculate a ratio of the diameters of the central region and surrounding region;
removing a surface layer of the composite body to produce a specific ratio of the diameters of the central region to the surrounding region; and
elongating and cutting the composite body to form a plurality of composite rods.

8. The method of claim 7, wherein the second refractive index is lower than said first refractive index.

9. The method of claim 8, wherein the core rod has a refractive index lower than said first refractive index.

10. A method of manufacturing a photonic bandgap fibre, comprising the steps of:
preparing a composite body having a central region of a first refractive index, and a surrounding region of a second refractive index;
measuring the refractive index profile of the composite body;
using the measured refractive index profile to calculate a ratio of the diameters of the central region and surrounding region;
removing a surface layer of the composite body to produce a specific ratio of the diameters of the central region to the surrounding region;
elongating and cutting the composite body to form a plurality of composite rods;
stacking the composite rods around a core rod;
inserting the stacked rods into a jacket tube to form an assembly; and
reducing the jacket tube and stacked rods into a fibre.

11. A method of manufacturing a photonic bandgap fibre, comprising the steps of:
preparing composite rods having a central region of a first refractive index, and a surrounding region of a second refractive index;
stacking the composite rods around a core rod;
inserting the stacked rods into a jacket tube to form an assembly;
flowing chlorine gas or a gas comprising a chlorine compound through the assembly; and
reducing the jacket tube and stacked rods into a fibre.
